(19) United States
(12) Patent Application Publication
(10) Pub. No.: US 2023/0071153 A1
(43) Pub. Date: Mar. 9, 2023

(54) ENCAPSULATED RATCHET AND METHOD OF MAKING THE SAME

(71) Applicant: APEX BRANDS, INC., Apex, NC (US)

(72) Inventors: Kai Zhang, Charlotte, NC (US); Zhihong Fu, Cary, NC (US); Charles Wang, Charlotte, NC (US); Brian Butler, Charlotte, NC (US)

(21) Appl. No.: 17/800,352

(22) PCT Filed: Mar. 3, 2021
(86) PCT No.: PCT/US21/20647

§ 371 Date: Aug. 17, 2022

Related U.S. Application Data
(60) Provisional application No. 62/985,111, filed on Mar. 4, 2020.

(51) Int. Cl. B25B 13/46; B23K 26/38; B29C 45/00; B29C 45/16

(52) U.S. Cl. CPC B25B 13/462; B23K 26/38; B29C 45/0005; B29C 45/1671; B29K 2705/12

(57) ABSTRACT

A hand tool includes an elongate, plate shaped steel core having a top face and a bottom face in parallel planes, a drive head portion formed at one end of the steel core and having a drive head cavity formed therein, a tang portion extending from the drive head portion to the other end of the steel core, a ratchet assembly disposed in the drive head cavity, and a first encapsulation layer covering the tang portion and the drive head portion, but not covering at least a portion of the ratchet assembly. The first encapsulation layer may include a fiber reinforced plastic composite material.

### TECHNICAL FIELD

Example embodiments generally relate to hand tools and, in particular, relate to a ratchet having a lighter weight and simpler construction steps than conventional wrenches, and a method of making the same.

### BACKGROUND

Hand tools are commonly used across all aspects of industry and in the homes of consumers. Hand tools are employed for multiple applications including, for example, tightening, component joining, and/or the like. For some tightening applications, a ratchet, and particularly a ratchet incorporating a ratchet assembly, which is referred to as a ratcheting ratchet wrench (or simply as a “ratchet”), may be preferred. These familiar hand tools typically allow any of a number of different sized sockets to be mated with a drive square. The ratchet further allows turning the socket with the wrench in only one, typically selectable, direction.

The ratchet assembly, which often includes a toothed gear that interfaces with a pawl. The pawl interfaces with the gear to allow movement of the pawl over the teeth in one direction (e.g., to reset the position of the wrench for application of torque for tightening or loosening a fastener). However, the pawl does not allow movement over the teeth in the other direction so that torque can be applied due to rotation of the wrench, and therefore also the drive square and the attached socket.

These familiar and very popular devices are typically made by initially cutting steel bars into billets using a shearing machine. The billets are then heated (e.g., via an induction coil) to very high temperatures (>1200° C.). A forge press is then used to shape the now very hot billets into the desired shape of the ratchet wrench in a process referred to as hot forging. Although a body cavity is formed as part of the hot forging process, the body cavity must still be machined to prepare the body cavity for reception of the gear assembly or ratchet assembly. The ratchet wrench is cleaned and processed using a lathe to provide the desired shape or design features (including features for interfacing with a non-metallic handle) that should be included on the ratchet wrench. Heat treatment is then performed in order to harden the metal. Subsequently, the ratchet is subject to surface cleaning using e.g. vibratory equipment with chemicals and milling media. Finish may then be applied (e.g., nickel or chrome plating), and the application of these finishes often involve the use of chemicals. The ratchet assembly is then inserted into the body cavity. Thereafter, non-metallic handles or other design elements can be added. Moreover, in some cases, the entire ratchet (except the drive square and portions of the ratchet assembly) may also be coated with non-metallic materials in order to insulate the tools for use in electrically active environments.

As can be appreciated from the description above, there are a very large number of steps that go into the making of a typical ratchet wrench. Moreover, these steps include a number of individual steps that are expensive, arguably harmful to the environment and/or time consuming. Thus, it may be desirable to provide an improved ratchet wrench and method of making the same.

### BRIEF SUMMARY OF SOME EXAMPLES

In an example embodiment, a hand tool may be provided. The hand tool may include an elongate, plate shaped steel core having a top face and a bottom face in parallel planes, a drive head portion formed at one end of the steel core and having a drive head cavity formed therein, a tang portion extending from the drive head portion to the other end of the steel core, a ratchet assembly disposed in the drive head cavity, and a first encapsulation layer at least partially covering the tang portion and the drive head portion, but not covering at least a portion of the ratchet assembly. The first encapsulation layer may include a fiber reinforced plastic composite material.

In another example embodiment, a method for manufacturing a hand tool may be provided. The method may include a laser cutting a steel core from a steel plate, forming a drive head cavity proximate to a first end of the steel core, applying a first encapsulation layer comprising a fiber reinforced plastic composite material over the steel core via injection molding, and assembling a ratchet assembly into the drive head cavity to define a ratchet.

In another example embodiment, another method of manufacturing a hand tool is provided. The method may include stamping a steel core from a steel plate, forming a drive head cavity proximate to a first end of the steel core, applying a first encapsulation layer comprising a fiber reinforced plastic composite material over the steel core via injection molding, and assembling a ratchet assembly into the drive head cavity to define a ratchet.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a steel plate with a blank profile thereon according to an example embodiment;

FIG. 2 is a perspective view of a blank (or steel core) cut from the steel plate of FIG. 1 according to the blank profile, and a ratchet assembly that can be inserted into a drive head cavity formed in the blank in accordance with an example embodiment;

FIG. 3 is perspective view of the ratchet assembly inserted into the drive head cavity of the blank in accordance with an example embodiment;

FIG. 4 a perspective view of a ratchet formed by applying encapsulation layers over the device of FIG. 3 in accordance with an example embodiment;

FIG. 5 illustrates a block diagram of a method of making a ratchet in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a ratchet (e.g., a ratchet) with an improved design that enables the production of a superior product with fewer steps. Example embodiments may avoid a number of steps by either eliminating such steps or replacing them with more advanced processes and simpler steps that still provide a superior finished product. In this regard, for example, hot forging, machining steps, plating and finishing steps and even some intermediate cleaning steps may be removed from the production process. Example embodiments may employ laser cutting of a steel core instead of hot forging and machining. The steel core may then be encapsulated in a composite material (e.g., glass fiber reinforced plastic (GFRP) or carbon fiber reinforced plastic) to provide the final desired shape. The resulting ratchet is produced more simply, and easily, but is also lighter and electrically insulated, while still remaining durable and cosmetically attractive.

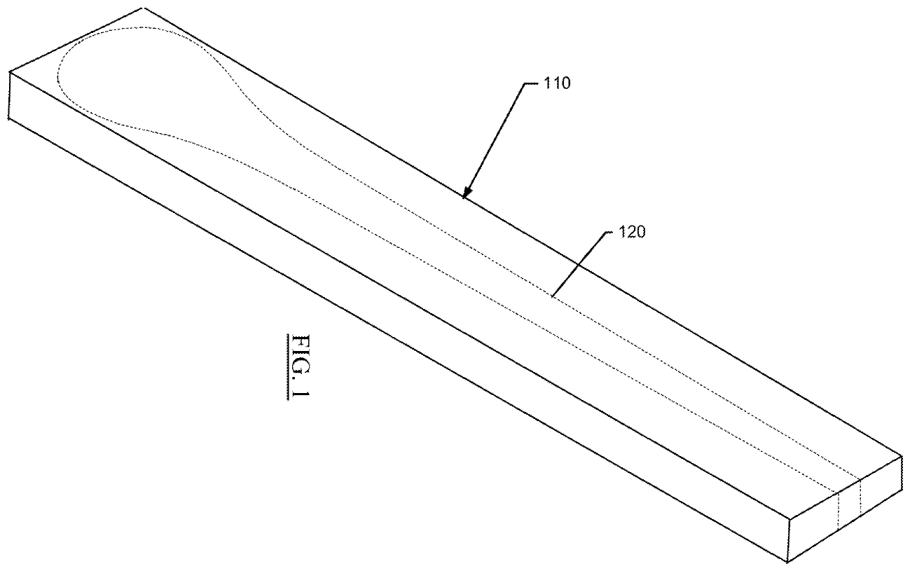

FIGS. 1-4 illustrate various stages in the production of a ratchet 100 according to an example embodiment. In this regard, FIG. 1 illustrates a metal billet or steel plate 110. The steel plate 110 may have a standard thickness (T) that will be the same thickness expected to form a core portion of the ratchet 100. In an example embodiment, the thickness of the steel plate 110 may be about 8-25 mm. A minimum thickness of about 8.56 mm may be employed for some embodiments. The length (L) and width (W) of the steel plate 110 may be cut or selected to ensure sufficiency for the expected length and width of the ratchet 100 as well. For example, a thickness of the steel plate 110 may be increased for ½ inch drive ratchets or may be decreased for ¼ inch drive ratchets.

After the steel plate 110 is cut or otherwise selected, the steel plate 110 may be heat treated or annealed for hardness. The steel plate 110 may also be sand blasted or otherwise cleaned after the heat treatment or annealing. However, the steel plate 110 could be purchased or otherwise supplied with heat treatment and/or cleaning already having been applied thereto. The steel plate 110 may then be laser cut to a blank profile 120 shown in FIG. 1. The blank profile 120 provides the outline shape that is desired for the core portion of the ratchet 100. Of note, an alternative to laser cutting may be stamping, water jet cutting, wire electrical discharge machining (EDM), or plasma cutting, etc. However, in either case, hot forging is not employed.

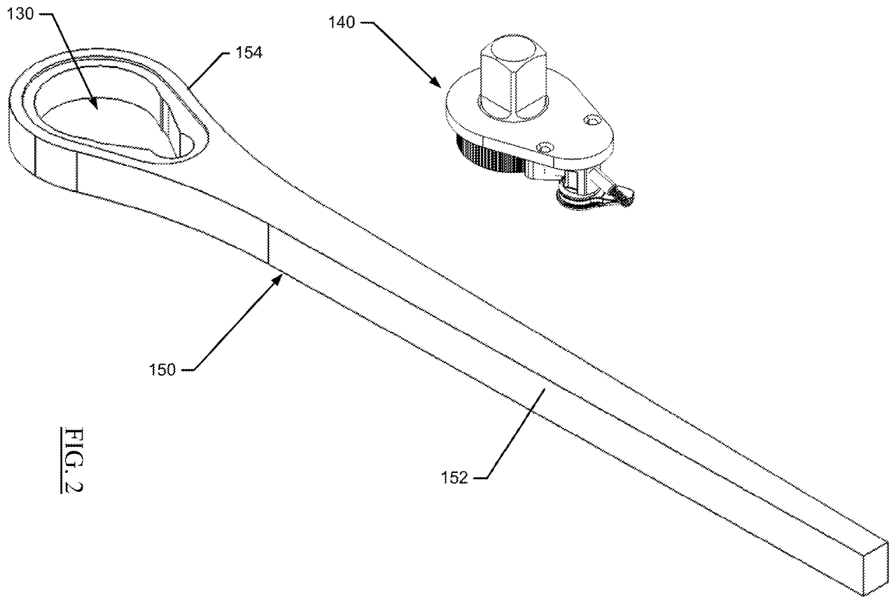

In some cases, laser cutting may also be employed to form the body cavity (or drive head cavity 130) inside which a ratchet assembly 140 will ultimately be provided. However, unless the drive head cavity 130 extends all the way through the steel plate 110, the drive head cavity 130 is generally formed by machining. Moreover, even if roughly formed using laser cutting, the formation of the drive head cavity 130 will typically require further machining to create the final shape shown in FIG. 2. For example, a shoulder or step may be formed around the driving head cavity 130 to interface with a front plate of ratchet assembly 140. A depth of the step may be about 0.3 to about 0.5 mm in some cases. Thus, responsive to laser cutting and/or any needed machining, a blank 150 is produced as shown in FIG. 2.

The blank 150 of FIG. 2 is also considered to be a steel core for the ratchet 100. Moreover, the steel core that comprises the blank 150 of FIG. 2 is structurally distinct from the metallic core of hand tools made by traditional means, even if such tools are coated at some point. In this regard, the steel core of the blank 150 remains plate shaped (e.g., having a top face and bottom face that lie entirely in parallel planes, and possibly also edges that transition to the perpendicularly extending sidewalls that connect the top and bottom faces—although edges may be deburred in some cases). Whereas a typical ratchet tool has a cylindrical core that is the result of using and machining a cylindrical billet using the processes described above which was subject to the hot forging, the steel core (or blank 150) of the ratchet 100 of an example embodiment is plate shaped and much simpler and easier to fabricate.

The blank 150 includes a tang portion 152 and a drive head portion 154. The drive head cavity 130 may extend entirely or partially through the drive head portion 154 and define a receiving space that is formed to fit the components of the ratchet assembly 140 therein. The blank 150 may be treated at this stage (e.g., via black oxide treatment or other similar processes). After any desired treatment of the blank 150, an encapsulation procedure may be performed and the ratchet assembly 140 may be installed into the drive head cavity 130. The order of encapsulation and installation of the drive head cavity 130 could be changed in different embodiments depending on the desired characteristics of the end product.

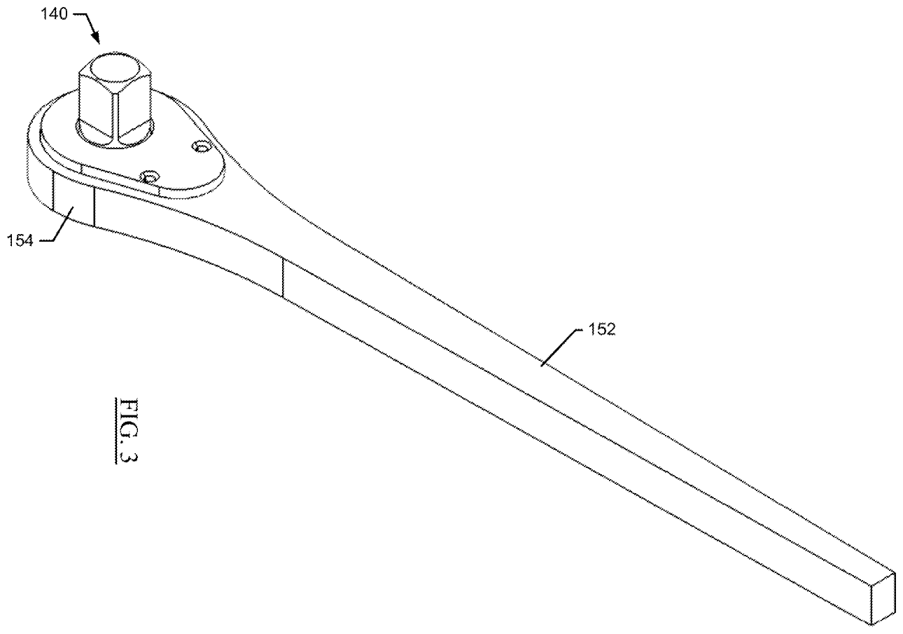

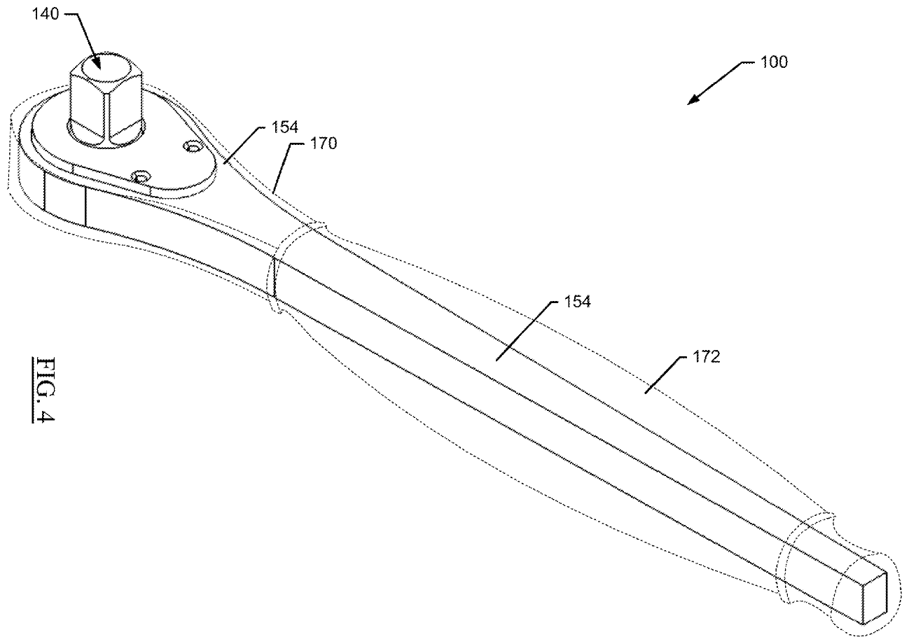

In one example, as shown in FIG. 3, the ratchet assembly 140 may be installed into the drive head cavity 130 before encapsulation (which is then shown in FIG. 4). However, it should be appreciated that encapsulation could alternatively be performed first, and then the ratchet assembly 140 may be installed into the drive head cavity 130. In either case, following encapsulation, the resultant ratchet 100 is shown in FIG. 4.

Encapsulation may include at least one (and sometimes two) layers of non-metallic material being applied to the blank 150. In an example embodiment, a first encapsulation layer 170 (and sometimes the only encapsulation layer) may be or include a composite material such as GFRP. The first encapsulation layer 170 may be defined with either a consistent thickness over the surface of the blank 150, or the thickness may vary based on the location on the blank 150. For example, the thickness of the first encapsulation layer 170 may be relatively constant proximate to the drive head portion 154. The thickness of the first encapsulation layer 170 in this region may be between about 1 mm to about 5 mm. However, in some cases, a thickness of between about 2-3 mm may be employed. Meanwhile, proximate to the tang portion 152, either a greater thickness (or a thickness that transitions to a larger amount farther from the drive head portion 154) may be employed. For example, about ⅓ of the length of the tang portion 152 extending away from the drive head portion 154 may include GFRP having the same thickness as that of the drive head portion 154. Thereafter, which may correspond to a position of the handle, the thickness may increase substantially on the top and bottom of the tang portion 152 in order to form a rounded grip on the handle. However, the GFRP can be molded to have any shape (i.e., including non-rounded shapes).

The encapsulation with the first encapsulation layer 170 may be provided with GFRP via an injection molding process. This enables a relatively simple and cost effective method for encapsulating the ratchet 100, but also gives a great deal of flexibility to defining design or comfort features for the handle, and for any other areas where specific design elements are planned or desired. The GFRP may, for examples, be a composition of polyamide or nylon 6 along with 60% glass fiber. The mechanical properties of the first encapsulation layer 170 may include an elastic modulus of 22 GPa, a bending strength of 50 KSI (345 MPa) and an ultimate tensile strength of 35.5 KSI (245 MPa).

Accordingly, the first encapsulation layer 170 may be relatively light weight, but very strong material. Moreover, the material may be relatively easy to apply to allow for wide variances in shape and design features without much difficulty. The GFRP is abrasion resistant, also resists corrosion, and can be used in cold weather. The GFRP is also insulating, so the ratchet 100 may provide protection against electric shock.

In some cases, a second encapsulation layer 172 may be provided over part or all of the first encapsulation layer 170. For example, in some cases, the second encapsulation layer 172 may only be provided on the handle in order to provide grip, texture, coloring, branding, etc. However, the second encapsulation layer 172 could be provided also at other locations or, as noted above, as an outer shell for the entire ratchet 100 (except perhaps some or all portions of the ratchet assembly 140). In an example embodiment, the second encapsulation layer 172 may also be applied via injection molding and may include thermoplastic polyurethane elastomer (TPU) or polyvinyl chloride (PVC). Thus, for example, the second encapsulation layer 172 may provide additional protection against electric shock, since the TPU or PVC material has good insulation properties.

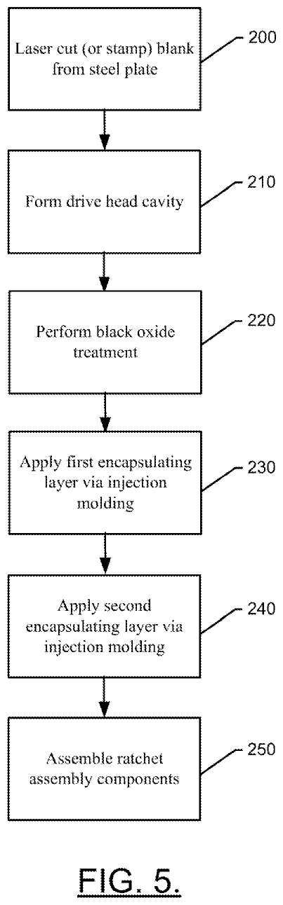

FIG. 5 illustrates a block diagram of a method of making a ratchet in accordance with an example embodiment. The method may include laser cutting (or stamping) a blank (or steel core) from a steel plate at operation 200. As noted above, the steel plate may undergo initial treatment steps including preheating treatments and/or sand blasting or other cleaning processes prior to operation 200. However, those steps may be performed by a supplier before the steel plate arrives at a facility that will process the steel plate according to the method of FIG. 5. The blank or steel core may be cut according to a blank profile.

Thereafter, a drive head cavity may be formed in the blank at operation 210. As noted above, this operation may be performed by machining (e.g., via a computer numerical control (CNC) machine tool). Although not required, the method may further include operation 220, which includes the performance of a metal treatment step such as black oxide treatment. The method may further include applying a first encapsulation layer via injection molding at operation 230. The material used for the first encapsulation layer may be GFRP. In some cases, the method may include a further (and optional) application of a second encapsulation layer (or additional layers) also via injection molding at operation 240. Additional layers (e.g., 3rd, 4th and so on) may also be provided in some cases. If the second encapsulation layer is employed, the material used may be, for example, a TPU or PVC over-mold. At operation 250, the ratchet assembly may be inserted into the drive head cavity and the ratchet may be fully assembled.

As noted above, some embodiments may only include one layer (i.e., the first encapsulation layer comprising GFRP. Additionally, it should be noted that operation 250 could be performed prior to operation 230 in some alternative embodiments. Thus, for example, the ratchet assembly could be inserted into the drive head cavity prior to the performance of the application of the first encapsulation layer. In other words, some of the operations in FIG. 5 could be performed in different orders. However, as also noted above, some of the operations may also be omitted in some embodiments.

As can be appreciated from the example of FIGS. 1-5, example embodiments may define a hand tool with a simplified manufacturability at much less processing steps. The resulting hand tool may also be significantly lighter than a similarly sized hand tool that is made according to conventional methods. In this regard, a conventionally made ratchet has more metal mass therein, and is therefore heavier. The additional weight can cause users to become fatigued after long use of the hand tool. Such metal hand tools are also generally not usable in areas where electrical charges may be present due to their conductive nature. However, the hand tool of an example embodiment is necessarily insulated by virtue of its encapsulation of the metal parts in insulating materials. These insulating materials not only insulate against electric shock, but are also effective in insulating against the cold. Thus, a metallic tool which is stored outside, which can become extremely cold in winter, may be nearly unusable by a user due to the temperature of the tool. However, hand tools according to example embodiments can be stored in cold environments and immediately picked up and handled by users (without gloves or other precautions) due to the insulation provided by the encapsulating material.

Among the advantages provided by example embodiments, it is notable that hot forging, vibratory cleaning and chromium/nickel plating can each be completely eliminated as a step in the formation of the hand tool. Hot forging is a costly process that generates significant waste. Thus, both the costs and waste products otherwise applicable to hand tool production via hot forging can be avoided by employing example embodiments. Additionally, example embodiments involve significantly less metal removal and corresponding metallic material waste. The ability to completely avoid chromium and/or nickel plating also avoids both cost and concern for generation of potentially harmful waste products.

Accordingly, a hand tool of an example embodiment may include an elongated, plate shaped steel core having a top face and a bottom face in parallel planes, a drive head portion formed at one end of the steel core and having a drive head cavity formed therein, a tang portion extending from the drive head portion to the other end of the steel core, a ratchet assembly disposed in the drive head cavity, and a first encapsulation layer covering the tang portion and the drive head portion, but not covering at least a portion of the ratchet assembly. However, in some cases, the tang portion or the drive head portion could be partially covered (e.g., to expose the steel core). The first encapsulation layer may include a fiber reinforced plastic composite material (e.g., glass fiber or carbon fiber).

The hand tool may include a number of modifications, augmentations, or optional additions, some of which are described herein. The modifications, augmentations or optional additions may be added in any desirable combination. For example, the first encapsulation layer may be injection molded over the tang portion and the drive head portion. It can be entirely covered or partially covered, but the portion for components assembly should be uncovered. In an example embodiment, the glass fiber reinforced plastic composite material may include a composition of nylon 6 and about 10% to about 80% glass fiber (e.g., 60%). In some cases, the first encapsulation layer may include non-uniform depths measured to the steel core at the tang portion relative to the drive head portion. In an example embodiment, depth of the first encapsulation layer proximate to the drive head portion may be between about 1 mm and about 3 mm, and depth of the first encapsulation layer proximate to the drive tang is greater than about 3 mm. In some cases, a second encapsulation layer may be applied over the first encapsulation layer. In an example embodiment, the second encapsulation layer may be injection molded and may include TPU or PVC. In some cases, a 3^{rd} and/or 4^{th} encapsulation layer may be applied over the last over-molded layer. In some cases, the 2^{nd}, 3^{rd} and/or 4^{th} layer may be fabricated separately by injection molding, and then inserts onto the 1^{st} encapsulated GFRP layer. In some cases, the steel core may be black oxide treated prior to application of the first encapsulation layer. In an example embodiment, the steel core may be laser cut or stamped. In some cases, the steel core may be defined by the top face, the bottom face and perpendicularly extending sidewalls there between to connect the top and bottom faces.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
an elongate, plate shaped steel core having a top face and a bottom face in parallel planes;
a drive head portion formed at one end of the steel core and having a drive head cavity formed therein;
a tang portion extending from the drive head portion to the other end of the steel core;
a ratchet assembly disposed in the drive head cavity; and
a first encapsulation layer at least partially covering the tang portion and the drive head portion, but not covering at least a portion of the ratchet assembly,
wherein the first encapsulation layer comprises a fiber reinforced plastic composite material.

2. The hand tool of claim 1, wherein the first encapsulation layer is injection molded over the tang portion and the drive head portion.

3. The hand tool of claim 2, wherein the fiber reinforced plastic composite material comprises a composition of glass fiber reinforced plastic composite material and about 10% to about 80% glass fiber.

4. The hand tool of claim 1, wherein the first encapsulation layer has non-uniform depths measured to the steel core at the tang portion relative to the drive head portion.

5. The hand tool of claim 4, wherein depth of the first encapsulation layer proximate to the drive head portion is between about 0.1 mm and about 10 mm, and
wherein depth of the first encapsulation layer proximate to the ratchet tang is greater than about 1 mm.

6. The hand tool of claim 1, wherein a second encapsulation layer is applied over the first encapsulation layer.

7. The hand tool of claim 6, wherein the second encapsulation layer is injection molded and comprises thermoplastic polyurethane (TPU) or polyvinyl chloride (PVC).

8. The hand tool of claim 1, wherein the steel core is black oxide treated prior to application of the first encapsulation layer.

9. The hand tool of claim 1, wherein the steel core is laser cut, stamped, plasma cut, water jet cut, or cut by electrical discharge machining (EDM).

10. The hand tool of claim 1, wherein the steel core is defined by the top face, the bottom face and perpendicularly extending sidewalls therebetween to connect the top and bottom faces.

11. A method of manufacturing a hand tool, the method comprising:
laser cutting a steel core from a steel plate;
forming a drive head cavity proximate to a first end of the steel core;
applying a first encapsulation layer comprising a fiber reinforced plastic composite material over the steel core via injection molding; and
assembling a ratchet assembly into the drive head cavity to define a ratchet.

12. The method of claim 11, wherein applying the first encapsulation layer comprises injection molding glass fiber reinforced plastic composite material over both a tang portion and a drive head portion of the steel core.

13. The method of claim 12, wherein the glass fiber reinforced plastic composite material comprises a composition of nylon 6 and about 10% to about 80% glass fiber.

14. The method of claim 12, wherein applying the first encapsulation layer comprises applying the first encapsulation layer to non-uniform depths measured to the steel core at the tang portion relative to the drive head portion.

15. The method of claim 14, wherein applying the first encapsulation layer comprises applying the first encapsulation layer to a depth of between about 0.1 mm and about 10 mm proximate to the drive head portion, and applying the first encapsulation layer to a depth of greater than about 1 mm proximate to the drive tang.

16. The method of claim 11, further comprising applying a second encapsulation layer over the first encapsulation layer.

17. The method of claim 16, wherein applying the second encapsulation layer comprises injection molding thermoplastic polyurethane (TPU) or polyvinyl chloride (PVC) over the first encapsulation layer.

18. The method of claim 11, further comprising applying a black oxide treated to the steel core prior to application of the first encapsulation layer.

19. The method of claim 11, wherein laser cutting the steel core comprises forming the steel core as an elongated plate including a top face, a bottom face and perpendicularly extending sidewalls therebetween to connect the top and bottom faces.

20. A method of manufacturing a hand tool, the method comprising:
stamping a steel core from a steel plate;
forming a drive head cavity proximate to a first end of the steel core;
applying a first encapsulation layer comprising a fiber reinforced plastic composite material over the steel core via injection molding; and
assembling a ratchet assembly into the drive head cavity to define a ratchet.
